(19) United States
(12) Patent Application Publication
(10) Pub. No.: US 2011/0321076 A1
(43) Pub. Date: Dec. 29, 2011

(54) VIEWING TERMINAL DEVICE, SERVER DEVICE, AND PARTICIPATING PROGRAM SHARING SYSTEM

(75) Inventors: Kou MATSUOKA, Osaka (JP); Takesi Umeda, Osaka (JP); Yasunori Kawakami, Hyogo (JP); Yasunori Naruse, Shiga (JP); Miki Shimizu, Osaka (JP)

(73) Assignee: Panasonic Corporation, Osaka (JP)

(21) Appl. No.: 13/218,085

(22) Filed: Aug. 25, 2011

Related U.S. Application Data
(63) Continuation of application No. PCT/JP2010/000851, filed on Feb. 12, 2009.

(30) Foreign Application Priority Data
Mar. 3, 2009 (JP) 2009-048948

(51) Int. Cl. H04N 21/475; H04N 21/23

(52) U.S. Cl. 725/13

(57) ABSTRACT

A viewing terminal device transmits a viewing information and a comment information fetched using an input processing unit to a server device via a network. To display a video data of a broadcast program, the viewing terminal device issues a request to transmit a viewing statistical information and sends the transmission request to the server device, and receives and displays the viewing statistical information transmitted from the server device in response to the request to transmit the viewing statistical information.

### FIELD OF THE INVENTION

The present invention relates to a viewing terminal device having a broadcast reception/network function (for example, audio/video output device or audio/video recording and reproduction device), a server device connected to the viewing terminal device via a network, and a participating program sharing system, more particularly to a technology for accomplishing such an productive and interactive viewing environment that reflects viewers' empathy and emotions when, for example, they find a program amusing or interesting or develop the feelings of sadness watching a program.

### BACKGROUND OF THE INVENTION

In conventional systems disclosed so far, the history of programs (including commercial advertisement) viewed on a television or a cable television (CATV) is collected when a broadcast program is viewed or when a program recorded in a video recording device is viewed. These systems can obtain viewing rates of programs when broadcast programs or recorded programs are viewed (for example, see the Patent Document 1).

Further, there is a system which supports the creation and transmission of comment information on different scenes of a program (see the Patent Document 2).

### PRIOR ART DOCUMENT

### Patent Document

Patent Document 1: Unexamined Japanese Patent Applications Laid-Open No. 2002-305760
Patent Document 2 Unexamined Japanese Patent Applications Laid-Open No. 2003-339006

### SUMMARY OF THE INVENTION

### Problem to be Solved by the Invention

The conventional highlight replay function is not designed to accomplish such a productive and interactive viewing environment that reflects viewers' empathy and emotions when, for example, they find a scene of a program amusing or interesting or develop the feelings of sadness watching a scene of the program.

In the event that there is an expected development in a data broadcast program currently watched by a user, the user is actually unable to make a comment on the unexpected development and transmit the comment. Because the data broadcast currently available is a unidirectional broadcaster-oriented service, a program, if a user has questions, interest, or concern about the program against the broadcaster's intention, is never rebroadcasted or updated. Though such a comment could be posted on an Internet website, for example, bulletin board, the user could not access the website once the program started.

### Means for Solving the Problem

1) A viewing terminal device used in a participating program sharing system according to the present invention comprises:

a broadcast reception unit configured to receive a broadcast wave on which a video data of a broadcast program is superimposed;

a display unit configured to fetch the video data from the broadcast wave received by the broadcast reception unit and display thereon the fetched video data;

an input processing unit configured to create a viewing information pertinent to a viewing operation of the broadcast program performed by a user and a comment information based on a comment on the broadcast program inputted by the user;

a terminal-side network unit connected via a network to a server device configured to create a viewing statistical information of the broadcast program based on the viewing information and the comment information; and

a display operation decision unit interposed between the terminal-side network unit and the display unit, wherein

the terminal-side network unit transmits the viewing information and the comment information fetched by the input processing unit to the server device via the network,

the display operation decision unit issues a request to transmit the viewing statistical information and sends the transmission request to the server device via the terminal-side network unit when the video data is displayed on the display unit,

the terminal-side network unit receives the viewing statistical information transmitted from the server device via the network in response to the request to transmit the viewing statistical information and transfers the received viewing statistical information to the display operation decision unit,

the display operation decision unit transfers the viewing statistical information received from the terminal-side network unit to the display unit, and

the display unit displays thereon the viewing statistical information received from the display operation decision unit.

The viewing terminal device is basically equipped with no recording and reproduction function, and may be called an audio/video output device.

2) The video viewing device technically characterized as described in 1) further comprises:

a recording unit configured to record therein the video data; and

a reproduction unit configured to reproduce the video data recorded in the recording unit and output the reproduced video data to the display unit, wherein

the input processing unit further creates an operation information pertinent to a reproduction operation of the video data in the reproduction unit,

the terminal-side network unit transmits the operation information created by the input processing unit to the server device via the network, and

the server device creates the viewing statistical information based on the operation information, the viewing information, and the comment information.

The viewing terminal device having the recording and reproduction function may be called an audio/video recording and reproduction device.

3) A server device used in a participating program sharing system according to the present invention comprises:

a server-side network unit connected via a network to a viewing terminal device configured to receive a broadcast wave on which a video data of a broadcast program is superimposed, fetch the video data from the broadcast wave, and display the fetched video data;

an analysis unit configured to create a viewing statistical information of the broadcast program; and

a storage unit configured to store therein the created viewing statistical information, wherein

the server-side network unit receives via the network a viewing information pertinent to a viewing operation of the broadcast program and a comment information pertinent to the broadcast program respectively transmitted from the viewing terminal device,

the analysis unit analyzes the viewing information and the comment information received by the server-side network unit to create the viewing statistical information,

the server-side network unit receives a request to transmit the viewing statistical information from the viewing terminal device via the network,

the analysis unit reads the viewing statistical information from the storage unit when the server-side network unit receives the request to transmit the viewing statistical information, and outputs the read viewing statistical information to the server-side network unit, and

the server-side network unit transmits the inputted viewing statistical information to the viewing terminal device via the network.

The server device is comparable to the viewing terminal device equipped with no recording and reproduction function recited in 1).

4) The server device recited in 3) may be technically characterized in that;

the viewing terminal device records the video data and reproduces the recorded video data,

the server-side network unit further receives an operation information pertinent to a reproduction operation of the video image data transmitted from the viewing terminal device via the network, and

the analysis unit creates the viewing statistical information based on the operation information and the comment information.

The server device is comparable to the viewing terminal device equipped with the recording and reproduction function recited in 2).

The combination of the viewing terminal device and the server device technically characterized as described so far constitutes a participating program sharing system according to the present invention. The viewing terminal device and the server device are connected to the network.

Below are described functions of a participating program sharing system in which the viewing terminal device in 1) and the server device in 3) are combined.

In the viewing terminal device, the video data of the broadcast program channel-selected and received by the broadcast reception unit is displayed on the display unit so that the broadcast program is viewed by the user. The viewing information pertinent to the viewing operation of the broadcast program performed by the user and the comment information on the broadcast program inputted by the user are fetched from the input processing unit and transmitted to the terminal-side network unit. The viewing information includes, for example, a selected channel number, program ID, and a viewing time slot. The comment information includes, for example, the user's questions, interest, or concern, and the user's empathy and emotions developed by the program, for example, which scene is amusing, interesting or sad. The viewing information and the comment information are used as basic information to support the creation of the viewing statistical information such as a viewing rate and the record of viewing rates in each broadcast channel and program complementary information. The viewing information and the comment information are outputted from the terminal-side network unit to the server device via the network. The viewing information and the comment information are fetched by the server-side network unit of the server device and transmitted to the analysis unit. The analysis unit analyzes the received viewing information and comment information to create the viewing statistical information, and transmits the created viewing statistical information to the storage unit. To create the viewing statistical information, the analysis unit reads the last viewing statistical information from the storage unit to determine whether the current viewing statistical information is pertinent to the same program, and updates the viewing rate, record of viewing rates, and comment. The updated viewing statistical information is stored in the storage unit. The server device continues to receive the viewing information and the comment information transmitted from multiple viewing terminal devices connected to the network. Every time when the viewing information and the comment information are transmitted, the viewing statistical information created by the analysis unit is stored in the storage unit. As described so far, the server device collects and analyzes the viewing information and the comment information to identify which scenes of each broadcast program are more attracting the user, and creates the viewing statistical information indicating circumstances of the popular scenes. The circumstances include, for example, the user's reaction to the popular scenes.

Viewing a broadcast program using the viewing terminal device, when the display operation decision unit of the viewing terminal device issues the request to transmit the viewing statistical information, the terminal-side network unit outputs the request to transmit the viewing statistical information to the server device via the network. When the server-side network unit receives the request to transmit the viewing statistical information, the analysis unit of the server device reads the viewing statistical information from the storage unit and outputs the read information to the server-side network unit. The server-side network unit transmits the viewing statistical information to the terminal-side network unit of the viewing terminal device via the network. The terminal-side network unit transfers the received viewing statistical information to the display operation decision unit, and the display operation decision unit outputs the viewing statistical information to the display unit. Then, the viewing statistical information is displayed on the display unit. The user checks the viewing statistical information displayed on the display unit to decide the broadcast program he wants to watch (broadcast program channel-selected by the broadcast reception unit). The viewing information and the comment information of the broadcaster program thus channel-selected are collected in a manner similar to the description given so far and transmitted to the server device via the network.

Thus, the viewing statistical information includes the user's questions, interest, or concern, and empathy and emotions, for example, which scene is amusing, interesting, or sad. The viewing statistical information thus characterized is transmitted from the viewing terminal device to the server device to be collected there. Then, the server device transmits the collected viewing statistical information to the viewing terminal device in response to the transmission request from the viewing terminal device. The viewing terminal device can display the received viewing statistical information as a useful reference for the user to view the program. This provides such a productive and interactive viewing environment that the viewers' empathy and emotions for the program are incorporated.

Next are described functions of a participating program sharing system in which the viewing terminal device in 2) and the server device in 4) are combined.

In the viewing terminal device, the viewing statistical information is received from the server device when the recorded video data is reproduced so that the popular scenes attracting attention are selected or the comment is displayed. To reproduce the video data recorded in the viewing terminal device, the user's comment and the operation information for reproduction are transmitted to the server device, and the server device updates the viewing statistical information (for example, program complementary information) and sends the updated viewing statistical information to the viewing terminal device. When the viewing statistical information is thus updated, the popular scenes attracting attention are identified so that more accurate information can be offered.

The participating program sharing system according to the present invention can measure a degree of popularity of a program without imposing an additional burden on the user. Further, the system is configured to transmit questions and comment on a particular scene, thereby more specifically identifying any highlight scenes. Then, opinions can be exchanged more easily for any unexpected development of a program and displayed in real time while the program is being reproduced. This gives the viewers realistic sensations of sharing the program. Further, the program can be reproduced and enjoyed over and over again because the comment can be updated at all times.

The technical terms used in the viewing terminal device, the server device, and the participating program sharing system are described below.

The viewing information may include information pertinent to; broadcasting date and time, channel number, and broadcast region of the broadcast program, and program ID of the broadcast program obtained from an electronic program table.

The viewing information may further include information pertinent to a pre-change channel number and a post-change channel number of the broadcast program currently viewed.

The operation information may include information pertinent to details of a special reproduction and an interval of the reproduction when the special reproduction of the video data other than normal reproduction is performed by the reproduction unit.

The operation information may include information pertinent to an interval of the video data not yet produced when the video data recorded in the recording unit is erased therefrom.

The operation information may include information pertinent to an interval of the deleted video data when the video data recorded in the recording unit is partly deleted therefrom.

The operation information may include information pertinent to details of a program protect which disallows the video data recorded in the recording unit to be deleted therefrom.

The operation information may include information pertinent to a playlist point registration site of the video data recorded in the recording unit.

The operation information may include information pertinent to a dubbing operation of the video data recorded in the recording unit.

The operation information may include information pertinent to a reserved recording of the video data recorded in the recording unit.

The comment information may include information pertinent to:

the broadcast program viewed by the user;

a comment on the broadcast program made by the user; and

a scene of the broadcast program on which the comment is made.

The viewing statistical information may include information pertinent to:

a viewing rate in each channel of the broadcast wave;

changes of the viewing rate in each channel; and

a reservation recording ratio in each channel.

The reproduction unit may identify an arbitrary scene in the video data recorded in the recording unit based on the viewing statistical information and skips to and reproduces the arbitrary scene when the video data is reproduced.

The display unit may display thereon the comment inputted by the user based on a scene of the broadcast program on which the comment is made when the reproduction unit reproduces the video data.

The viewing statistical information may include:

a response made by the user on the comment displayed on the display unit; and

a program complementary information which helps the broadcast program to be better understood.

When the program complementary information is displayed on the viewing terminal device as useful information, it is easier to know what opinions and questions have been raised in relation to the program, providing a viewing environment more productive and interactive.

### Effect of the Invention

According to the present invention thus technically characterized, the viewing statistical information including viewers' empathy and emotions, for example, which scene is amusing, interesting, or sad, and the user's questions, interest, or concern are transmitted from the viewing terminal device to the server device and collected in the server device, and the viewing statistical information is transmitted from the server device to the viewing terminal device in response to the transmission request from the viewing terminal device, so that the viewing statistical information can be referenced when a program is viewed in the viewing terminal device. This offers such a productive and interactive viewing environment that the viewers' empathy and emotions for the program are incorporated. Other advantages are; the user can easily know which scene of a program is attracting attention without an additional burden, opinions can be exchanged more easily for any unexpected development of the program and displayed in real time while the program is being reproduced. This gives the viewers realistic sensations of sharing the program, and the program can be reproduced and enjoyed over and over again because the comments can be updated at all times.

### BRIEF DESCRIPTION OF THE DRAWINGS

FIG. 1 is a block diagram illustrating a structure of a participating program sharing system according to an exemplary embodiment 1 of the present invention.

FIG. 2 is an illustration of a viewing information, an operation information pertinent to a recorded program, and a comment information according to the exemplary embodiment 1.

FIG. 3 is an illustration of a viewing statistical information according to the exemplary embodiment 1.

FIG. 4 is an illustration of a recorded program in a second viewing terminal device (audio/video recording and reproduction device) according to the exemplary embodiment 1.

FIG. 5 is an illustration of a recorded program in a second viewing terminal device (audio/video recording and reproduction device) according to an exemplary embodiment 2 of the present invention.

FIG. 6 is a block diagram illustrating a structure of a participating program sharing system according to an exemplary embodiment 3 of the present invention.

FIG. 7 is an illustration of a viewing statistical information according to the exemplary embodiment 3.

FIG. 8 is an illustration of a screen displaying the viewing statistical information according to the exemplary embodiment 3.

FIG. 9 is a block diagram illustrating a structure of a participating program sharing system which underlies the technical idea of the present invention.

FIG. 10 is an illustration of a viewing information and a viewing statistical information which underlie the technical idea of the present invention.

FIG. 11 is an illustration of a screen displaying the viewing information and the viewing statistical information which underlie the technical idea of the present invention.

### EXEMPLARY EMBODIMENTS FOR CARRYING OUT THE INVENTION

Hereinafter, exemplary embodiments of a participating program sharing system according to the present invention are described in detail referring to the drawings. Prior to the exemplary embodiments, structural elements which underlie the technical idea of the present invention are described below.

Structural Elements which Underlie the Present Invention

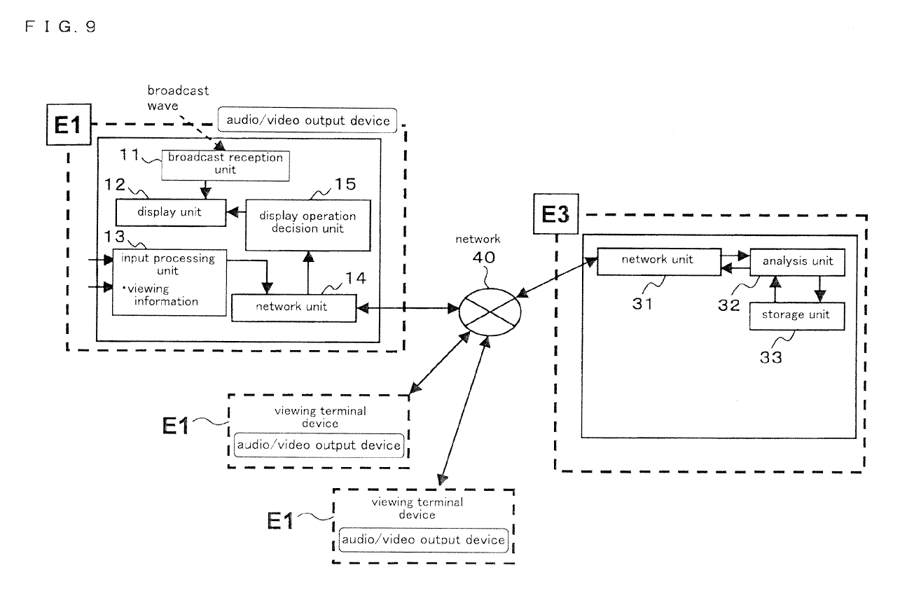

FIG. 9 is a block diagram illustrating a structure of a participating program sharing system which underlies the technical idea of the present invention. In FIG. 9, E1 is a viewing terminal device (audio/video output device), E3 is a server device, 40 is a network which interconnects the viewing terminal device E1 and the server device E3. In the drawing, a plurality of viewing terminal devices E1 are connected to the network 40.

The viewing terminal device E1 has a broadcast reception unit 11, a display unit 12, an input processing unit 13, a network unit (client side) 14, and a display operation decision unit 15. The server device E3 has a network unit (server side) 31, an analysis unit 32, and a storage unit 33.

The structural characteristics of the viewing terminal device E1 are described. The broadcast reception unit 11 receives a broadcast wave on which a broadcast program is superimposed. The broadcast reception unit 11 is connected to the display unit 12.

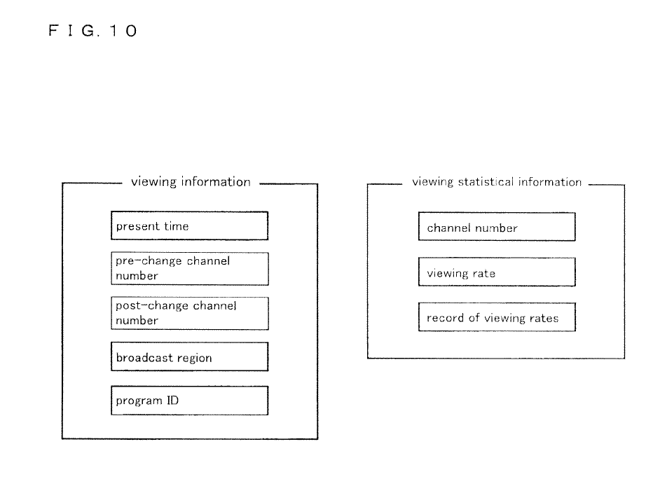

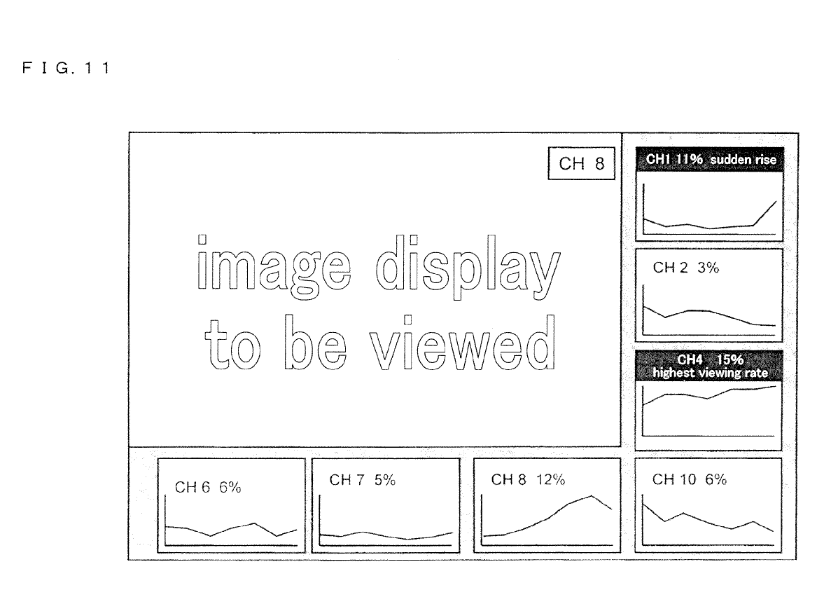

The display unit 12 is configured to:
fetch a video data of the broadcast program superimposed on the broadcast wave received by the broadcast reception unit 11 and display the fetched video data; and
display a viewing statistical information obtained from the server device E3 via the network unit 40 (see FIGS. 10 and 11).

The input processing unit 13 is configured to:
fetch a viewing information pertinent to a viewing operation of the broadcast program (see FIG. 10); and
transfer the fetched viewing information to the terminal-side network unit 14.

The viewing information includes:
present time point;
pre-change channel number and post-change channel number when there is any channel change in the received broadcast wave;
broadcast region; and
program ID of the viewed broadcast program (obtained from an electronic program table).

The terminal-side network unit 14 connected to the network 40 is configured to:
transmit the viewing information supplied from the input processing unit 13 to the network 40; and
transfer the viewing statistical information received from the server device E3 via the network 40 to the display operation decision unit 15.

The display operation decision unit 15 is configured to:
issue a request to transmit the viewing statistical information and send the transmission request to the terminal-side network unit 24 (further to the server device E3 via the terminal-side network unit 24) when the broadcast program is viewed; and
transfer the viewing statistical information transferred from the server device E3 via the terminal-side network unit 14 to the display unit 12.

The display operation decision unit 15 is interposed between the terminal-side network unit 14 and the display unit 12.

The display operation decision unit 15 is configured to issue the request to transmit the viewing statistical information and send the transmission request to the server device E3 based on an instruction inputted by a user or at periodical intervals.

Next, structural characteristics of the server device E3 are described.

The server-side network unit 31 of the server device E3 is configured to:
receive the viewing information transmitted via the network 40;
transfer the received viewing information to the analysis unit 32; and
transmit the viewing statistical information transmitted from the analysis unit 32 to the network 40.

The analysis unit 32 is configured to:
analyze the viewing information transferred from the server-side network unit 31 to thereby create the viewing statistical information;
transfer the generated viewing statistical information to the storage unit 33;
receive the request to transmit the viewing statistical information from the viewing terminal device E1 via the network 40;
read the requested reviewing statistical information from the storage unit 33 in response to the received transmission request; and
output the read viewing statistical information to the server-side network unit 31.

The storage unit 33 is configured to:
store therein the viewing statistical information created by the analysis unit 32; and
fetch the stored viewing statistical information upon request.

FIG. 10 illustrates examples of the viewing information and the viewing statistical information transmitted and received to and from the viewing terminal device E1 and the server device E3 via the network 40.

The viewing information includes:
present time point;
pre-change channel number;
post change channel number;
broadcast region; and
program ID obtained from an electronic program table.

A power switch ON and a power switch OFF can be displayed when the pre-change channel and the post-change channel are put to Null.

The viewing statistical information includes a current viewing rate and the record of past viewing rates in each channel calculated from the viewing information transmitted from all of the viewing terminal devices E1 connected to the network 40.

In the participating program sharing system according to the present exemplary embodiment thus technically characterized, the viewing rate in each channel can be calculated as described below. A view number counter is prepared for each of the channels currently broadcasting programs. Then, a counter value of the view number counter provided in the pre-change channel number is decreased by 1, and the counter value of the view number counter provided in the post-change channel number is increased by 1, so that the viewing rate in each channel is calculated. Further, a non-view number counter is prepared, and a counter value of the non-view number counter is decreased by 1 when the pre-change channel number is currently Null, and the counter value of the non-view number counter is increased by 1 when the post-change channel number is currently Null. Then, the viewing number of each channel is divided by sum of the view numbers and the non-view numbers of all the channels so that the viewing rate in each channel is calculated. In the case where the non-view number counters are not used, the viewing rate results in an overall occupancy.

FIG. 11 is an illustration of a screen where the received viewing statistical information is displayed in the viewing terminal device E1. The screen displays sub screen for a plurality of channels including their viewing rates around a main display region.

The participating program sharing system which underlines the present invention wherein no comment information is handled fails to offer such a productive and interactive viewing environment where viewers' empathy and emotions, for example, which scene is amusing, interesting, or sad are incorporated.

Hereinafter, exemplary embodiments of a participating program sharing system (viewing terminal device, server device) according to the present invention are described.

### Exemplary Embodiment 1

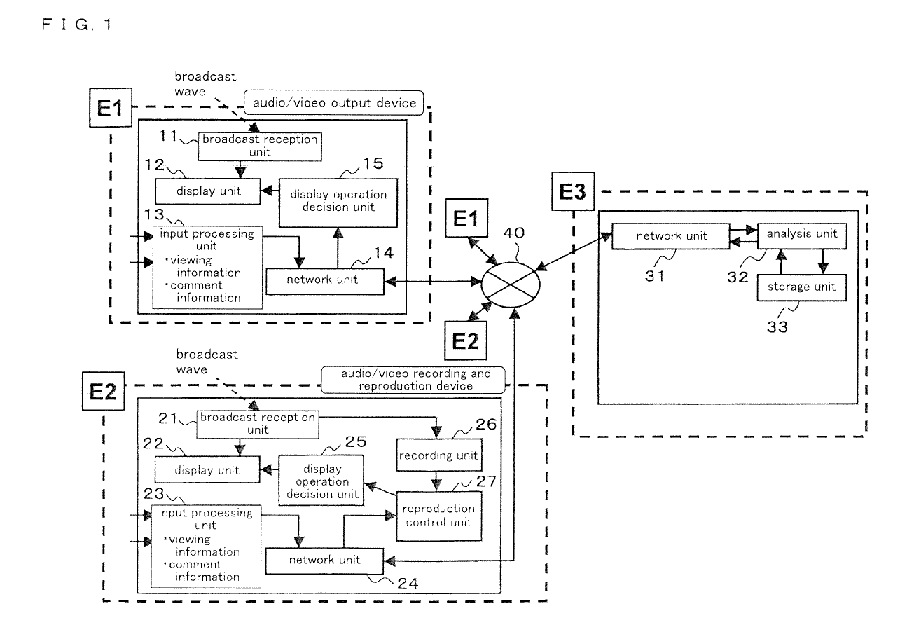

FIG. 1 is a block diagram illustrating a structure of a participating program sharing system according to an exemplary embodiment 1 of the present invention. In the participating program sharing system according to the present exemplary embodiment, a viewing terminal device (audio/video recording and reproduction device) E2 differently configured is added to the system configuration illustrated in FIG. 9. The viewing terminal device (audio/video output device) E1 is configured to create a comment information using an input processing unit 13 and output the comment information to the terminal-side network unit 14.

The viewing terminal device (audio/video recording and reproduction device) E2 has a broadcast reception unit 21, a display unit 22, an input processing unit 23, a terminal-side network unit 24, a display operation decision unit 25, a recoding unit 26, and a reproduction control unit 27.

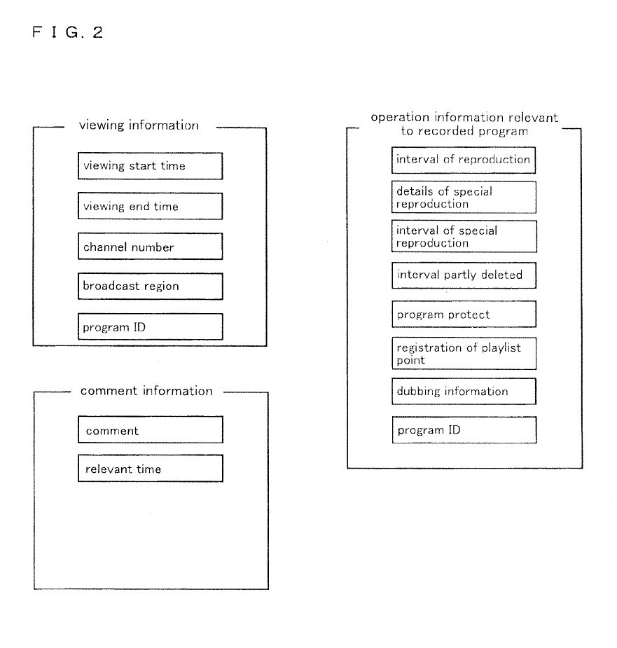

The input processing unit 23 is configured to:
create an operation information when a user views a broadcast program;
receive a comment on the viewed program inputted by the user and create the comment information (see FIG. 2) based on the received comment; and
transfer the fetched information to the terminal-side network unit 24.

The operation information includes information pertinent to:
details of a special reproduction when the special reproduction other than normal reproduction is performed;
interval of special reproduction in the program;
interval of the program not yet produced when the program is erased (information of any content recorded but not viewed by the user);
interval of the deleted program when the program is partly deleted;
program protect to disallow the program to be deleted;
a relevant scene of the program when a playlist point is registered;
dubbing operation;
reserved recording of the program;
reproduction of the program; and
editing.

The terminal-side network unit 24 connected to the network 40 is configured to:
transmit the viewing information, operation information, and comment information inputted from the input processing unit 23 to the server device E3 via the network 40;
receive the viewing statistical information from the server device E3 via the network 40; and
transfer the received viewing statistical information to the display operation decision unit 25.

The display operation decision unit 25 is configured to:
issue a request to transmit the viewing statistical information and send the transmission request to the terminal-side network unit 24 when the broadcast program is viewed or the recorded program is reproduced (further to the server device E3 via the terminal-side network unit 24); and
transfer the viewing statistical information transferred from the server device E3 via the terminal-side network unit 24 to the display unit 22.

The display operation decision unit 25 is configured to issue the request to transmit the viewing statistical information and send the transmission request to the server device E3 at periodical intervals or in response to an instruction inputted by the user. The display operation decision unit 25 is interposed between the terminal-side network unit 24 and the reproduction control unit 27.

The recording unit 26 is configured to:
store information of the program received from the broadcast reception unit 21; and
perform time-shifted reproduction (a broadcast program currently broadcasted can be displayed and recorded in the recording unit 26 at the same time, so that the broadcast program currently displayed can be halted or rewound).

The reproduction control unit 27 is configured to:
reproduce the program information stored in the recording unit 26;
receive information from the server device E3 via the network 40; and
transfer the received information to the display operation decision unit 25.

The server device E3 has a server-side network unit 31, an analysis unit 32, and a storage unit 33.

The server device E3 is configured to:
receive data from the viewing terminal device E1, E2 using the server-side network unit 31;
analyze the received data in the analysis unit 32 to create the viewing statistical information;
store the created viewing statistical information in the storage unit 33; and
transmit the viewing statistical information when requested so by the viewing terminal device E1, E2.

FIG. 2 is an illustration of the viewing information, operation information relevant to the recorded program, and comment information.

The viewing information includes information pertinent to:
viewing start time;
viewing end time;
channel number;
broadcast region; and
program ID.

In the viewing terminal device E1, the viewing information is extracted by the input processing unit 13 based on an instruction inputted by the user when the program is viewed.

The operation information relevant to the recorded program includes information pertinent to:
interval of reproduction;
details of special reproduction;
interval of special reproduction;
interval partly deleted
program protect;
registration of playlist point;
dubbing information; and
program ID.

In the viewing terminal device E2, the operation information is extracted by the input processing unit 23 based on an instruction inputted by the user when the recorded program is manipulated, such as reproduction, editing, or dubbing.

The comment information is created based on a comment inputted by the user, including:
comment on the program (opinion); and
relevant time point.

The viewing information, operation information relevant to the recorded program, and comment information are transmitted from the viewing terminal device E1, E2 to the server device E3.

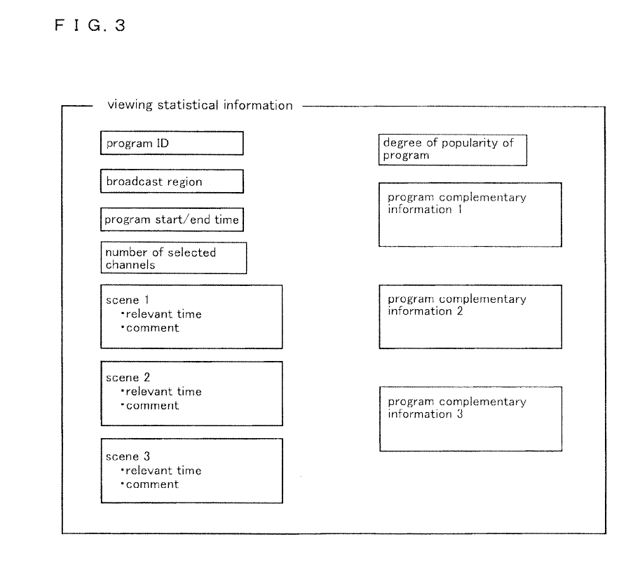

FIG. 3 is an illustration of the viewing statistical information. The viewing statistical information includes information pertinent to:
program ID;
broadcast region;
program start time;
program end time;
number of selected channels;
degree of popularity of the program;
scene; and
complementary program information.

The viewing statistical information is obtained as a result of the analysis performed by the analysis unit 32. The analysis unit 32 performs the analysis based on:
viewing information transmitted from the viewing terminal device E1, E2 to the server device E3;
operation information relevant to the recorded program; and
comment information.

As described earlier, the viewing statistical information includes information pertinent to:
program ID;
broadcast region;
program start time;
program end time;
number of selected channels; and
degree of popularity of the program.

When the program is viewed, the information included in the viewing statistical information is extracted by the analysis unit 32 based on the viewing information and the comment information transmitted from the viewing terminal device E1.

When the server device E3 transmits the viewing statistical information to the viewing terminal device E1, the viewing terminal device E1 can display the number of selected information channels and the degree of popularity in a manner suitable for the program to be viewed on the display unit 12.

The scene information is extracted by the analysis unit 32 based on the viewing information and the comment information transmitted from the viewing terminal device E1 when the program is viewed, and details of the scene information are analyzed by the analysis unit 32. The analysis unit 32 can update the scene information created at the time of viewing the program based on the operation information and the comment information transmitted from the viewing terminal device E2 when the recorded program is reproduced.

The recorded program complementary information is information created by the analysis unit 32 based on the comment information transmitted from the viewing terminal device E1, E2 to deepen understanding of the program and the given comment. The recorded program complementary information created at the time of viewing the program can be updated when the recorded program is reproduced based on the comment information transmitted from the viewing terminal device E2. When an unknown athlete plays an active role in spots, for example, a user might input a comment such as “I want to get information of the athlete”. When the comment information based on the comment is created, the recorded program complementary information is created based on the comment information. The recorded program complementary information is updated when the recorded program which involves the athlete is reproduced to help the user watch the recorded program.

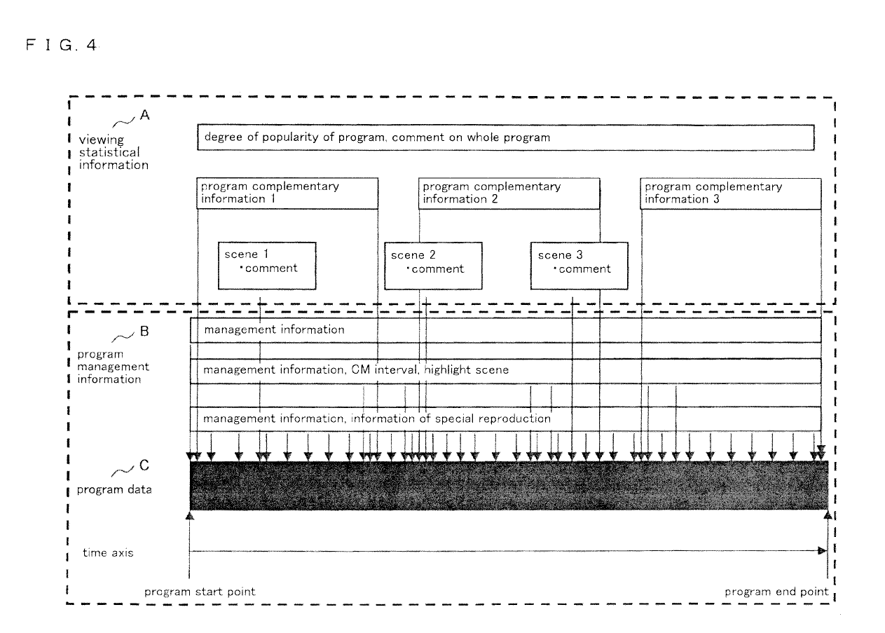

FIG. 4 is an illustration of a recorded program in the viewing terminal device E2. A program management information includes:
management information for a special reproduction of recorded program data; and
management information indicating CM intervals and highlight scenes of the program.

The program management information may be created solely when the viewed program is recorded in the viewing terminal device E2.

A viewing statistical information A is received from the server device E3 when the relevant program is reproduced in the viewing terminal device E2. When the viewing statistical information is received, a particular scene, comment, program complementary information, and a particular place in the program can be identified and used for reproduction.

In the system configuration illustrated in FIG. 1, the viewing terminal device (audio/video output device) E1 may be deleted so that the viewing terminal device (audio/video recording and reproduction device) E2 and the server device E3 aloe constitute the system.

### Exemplary Embodiment 2

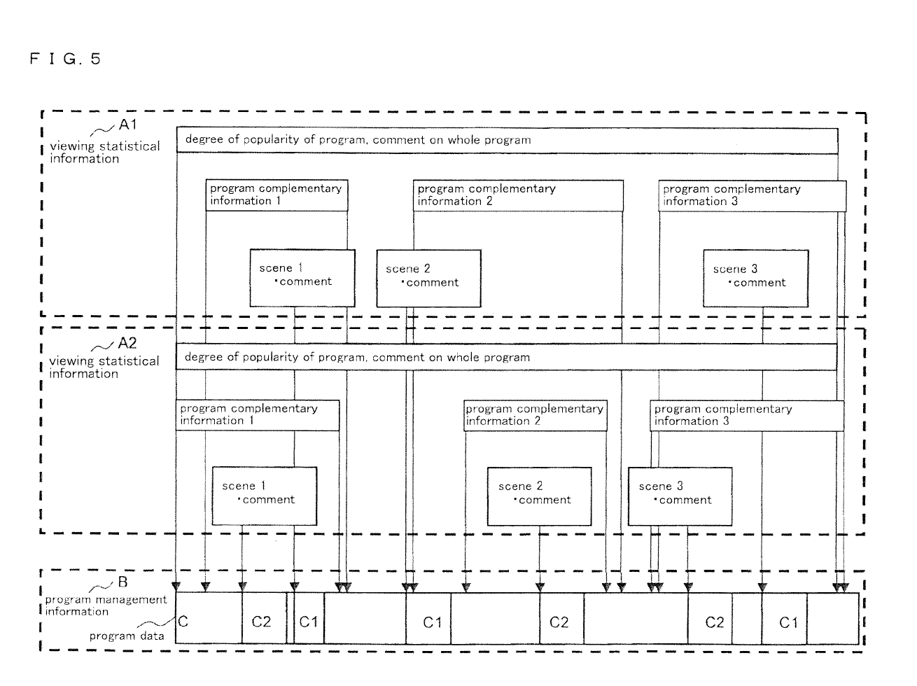

A participating program sharing system according to an exemplary embodiment 2 of the present invention provides two viewing statistical informations of a program. The present exemplary embodiment provides a system configuration and user operation similar to those illustrated in FIGS. 1-3 according to the exemplary embodiment 2. FIG. 5 illustrates a recorded program in a viewing terminal device E2 according to the exemplary embodiment 2.

A viewing statistical information A1 and a viewing statistical information A2 are configured equally to the viewing statistical information A illustrated in FIG. 4. The viewing statistical informations A1 and A2 are created by the analysis unit 32 based on different standpoints. It is assumed that the viewing statistical information A1 is created based on a first standpoint, and the viewing statistical information A2 is created based on a second standpoint.

A management information B is configured equally to the illustration of FIG. 4, and a program data C is configured equally to the illustration of FIG. 4. C1 is a highlight scene defined based on the first standpoint, and C2 is a highlight scene defined based on the second standpoint. When a program is reproduced, the viewing terminal device E2 receives the two viewing statistical informations A1 and A2, and the user chooses one of the informations according to his preference. As a result, the program can be enjoyed in the manner of multistory without modifying the main story of the program. The multistory is a broadcast program viewing method in which any of a plurality of separable stories can be selected and enjoyed. For example, sports-related programs are often viewed by a user with a preference on one team over the other. In these cases, the two viewing statistical informations are offered in the server device E3 so that the viewing environment can be more dynamic and enriched. This increases the user's empathy, remarkably helping the user to enjoy the program.

### Exemplary Embodiment 3

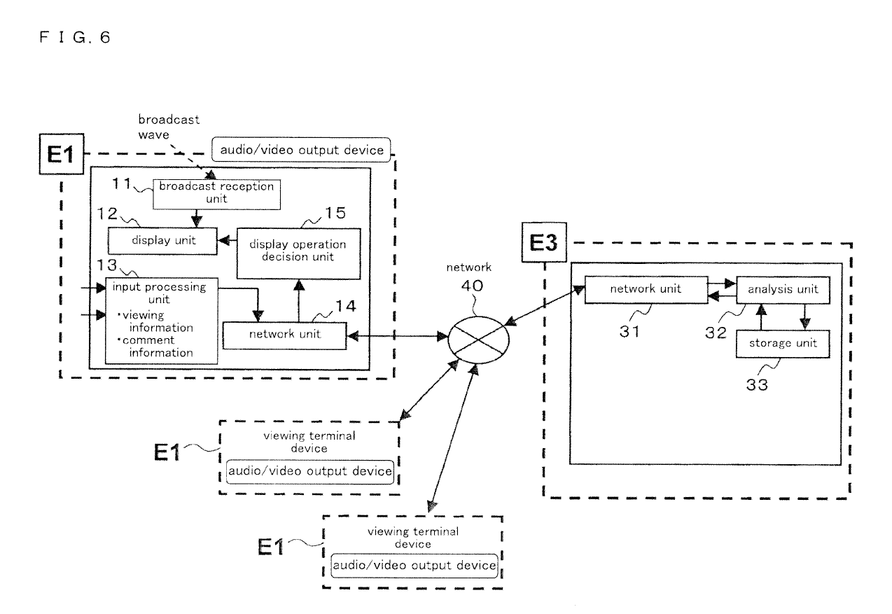

FIG. 6 is a block diagram illustrating a structure of a participating program sharing system according to an exemplary embodiment 3 of the present invention. In the participating program sharing system, the input processing unit 13 in the viewing terminal device E1 (no recording function) constituting the participating program sharing system illustrated in FIG. 9 is equipped with a function of creating a comment information. The input processing unit 13 creates the operation information when a user selects a channel or turns on or off a power switch, and receives a comment on a broadcast program inputted by the user and creates the comment information based on the received comment. The input processing unit 13 further transmits the created operation information and comment information to the server device E3 via the terminal-side network unit 14. The analysis unit 32 of the server device E3 creates a viewing statistical information based on the comment information and viewing information transmitted from a plurality of viewing terminal devices E1 and received by the server-side network unit 31.

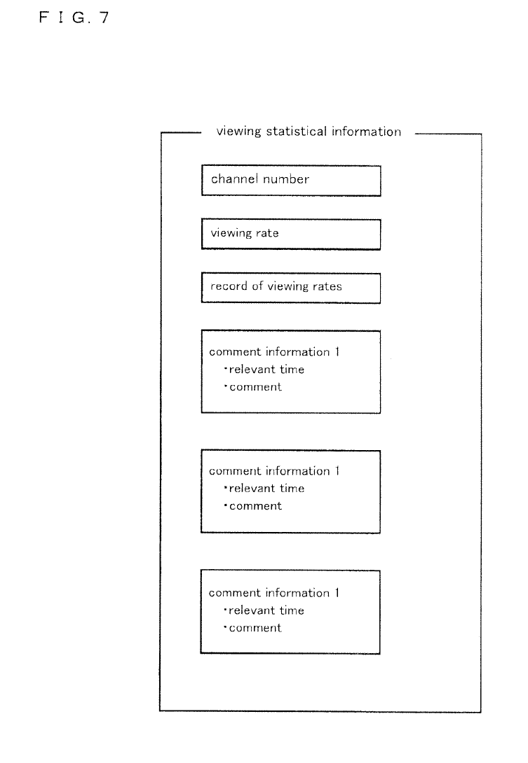

FIG. 7 is an illustration of the viewing statistical information according to the exemplary embodiment 3. The drawing illustrates the viewing statistical information of FIG. 1 to which the comment information transmitted from the viewing terminal device E1 is added.

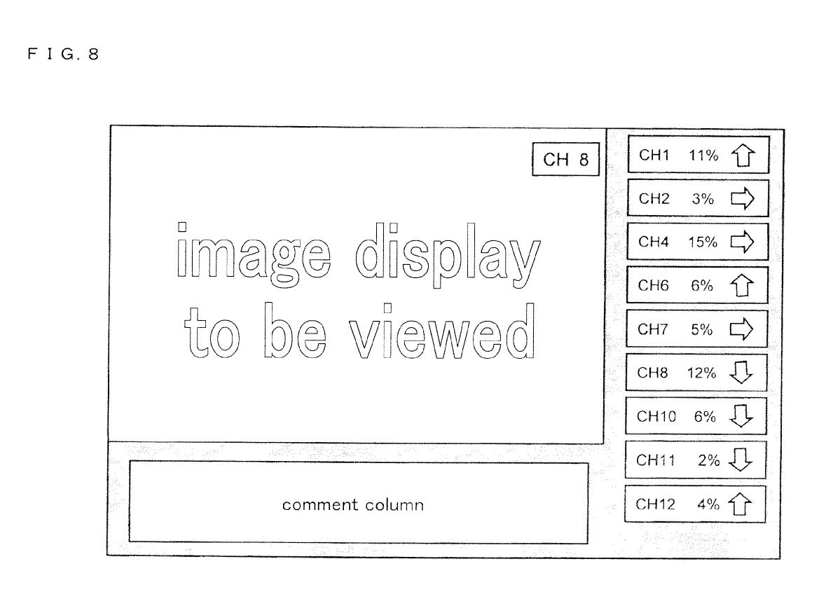

FIG. 8 illustrates a screen on which the received viewing statistical information is displayed in the viewing terminal device E1. The comment information is displayed as well as changing viewing rates of respective channels. Though no recording and reproduction function is provided, the viewing environment can be more productive and interactive than the prior art.

### INDUSTRIAL APPLICABILITY

The present invention collects a user's comment as well as a viewing record including operation information, thereby more accurately identifying any highlight scene of a program viewed by many users and other recommendable parts of the program suggested by the comment, for example, interested or emotionally attached. Further, the comment information displayed in real time during reproduction makes the program alive and interactive, and the information can be updated at all times so that the same program can be enjoyed when reproduced over and over again. The present invention provides such an advantageous technology for a participating program sharing system.

### DESCRIPTION OF REFERENCE SYMBOLS

E1 viewing terminal device (audio/video output device)
E2 viewing terminal device (audio/video recording and reproduction device)
E3 server device
11 broadcast reception unit
12 display unit
13 input processing unit
14 terminal-side network unit
15 display operation decision unit
21 broadcast reception unit
22 display unit
23 input processing unit
24 terminal-side network unit
25 display operation decision unit
26 recording unit
27 reproduction control unit
31 server-side network unit
32 analysis unit
33 storage unit
40 network

What is claimed is:

1. A viewing terminal device, comprising:
a broadcast reception unit configured to receive a broadcast wave on which a video data of a broadcast program is superimposed;
a display unit configured to fetch the video data from the broadcast wave received by the broadcast reception unit and display thereon the fetched video data;
an input processing unit configured to create a viewing information pertinent to a viewing operation of the broadcast program performed by a user and a comment information based on a comment on the broadcast program inputted by the user;
a terminal-side network unit connected via a network to a server device configured to create a viewing statistical information of the broadcast program based on the viewing information and the comment information; and
a display operation decision unit interposed between the terminal-side network unit and the display unit, wherein
the terminal-side network unit transmits the viewing information and the comment information fetched by the input processing unit to the server device via the network,
the display operation decision unit issues a request to transmit the viewing statistical information and sends the transmission request to the server device via the terminal-side network unit when the video data is displayed on the display unit,
the terminal-side network unit receives the viewing statistical information transmitted from the server device via the network in response to the request to transmit the viewing statistical information and transfers the received viewing statistical information to the display operation decision unit,
the display operation decision unit transfers the viewing statistical information received from the terminal-side network unit to the display unit, and
the display unit displays thereon the viewing statistical information received from the display operation decision unit.

2. The video viewing device as claimed in claim 1, further comprising:
a recording unit configured to record therein the video data; and
a reproduction unit configured to reproduce the video data recorded in the recording unit and output the reproduced video data to the display unit, wherein
the input processing unit further creates an operation information pertinent to a reproduction operation of the video data in the reproduction unit,
the terminal-side network unit transmits the operation information created by the input processing unit to the server device via the network, and
the server device creates the viewing statistical information based on the operation information, the viewing information, and the comment information.

3. A server device, comprising:
a server-side network unit connected via a network to a viewing terminal device configured to receive a broadcast wave on which a video data of a broadcast program is superimposed, fetch the video data from the broadcast wave, and display the fetched video data;
an analysis unit configured to create a viewing statistical information of the broadcast program; and
a storage unit configured to store therein the created viewing statistical information, wherein
the server-side network unit receives via the network a viewing information pertinent to a viewing operation of the broadcast program and a comment information pertinent to the broadcast program respectively transmitted from the viewing terminal device,
the analysis unit analyzes the viewing information and the comment information received by the server-side network unit to create the viewing statistical information,
the server-side network unit receives a request to transmit the viewing statistical information from the viewing terminal device via the network,
the analysis unit reads the viewing statistical information from the storage unit when the server-side network unit receives the request to transmit the viewing statistical information, and outputs the read viewing statistical information to the server-side network unit, and
the server-side network unit transmits the inputted viewing statistical information to the viewing terminal device via the network.

4. The server device as claimed in claim 3, wherein
the viewing terminal device records the video data and reproduces the recorded video data,
the server-side network unit further receives an operation information pertinent to a reproduction operation of the video image data transmitted from the viewing terminal device via the network, and
the analysis unit creates the viewing statistical information based on the operation information and the comment information.

5. The viewing terminal device as claimed in claim 1, wherein
the viewing information includes information pertinent to:
broadcasting date and time;
channel number;
broadcast region of the broadcast program; and
program ID of the broadcast program obtained from an electronic program table.

6. The server device as claimed in claim 3, wherein
the viewing information includes information pertinent to:
broadcasting date and time;
channel number;
broadcast region of the broadcast program; and
program ID of the broadcast program obtained from an electronic program table.

7. The viewing terminal device as claimed in claim 5, wherein
the viewing information further includes information pertinent to a pre-change channel number and a post-change channel number of the broadcast program currently viewed.

8. The server device as claimed in claim 6, wherein
the viewing information further includes information pertinent to a pre-change channel number and a post-change channel number of the broadcast program currently viewed.

9. The viewing terminal device as claimed in claim 2, wherein
the operation information includes information pertinent to details of a special reproduction and an interval of the reproduction when the special reproduction of the video data other than normal reproduction is performed by the reproduction unit.

10. The server device as claimed in claim 4, wherein
the operation information includes information pertinent to details of a special reproduction and an interval of the reproduction when the special reproduction of the video data other than normal reproduction is performed by the reproduction unit.

11. The viewing terminal device as claimed in claim 2, wherein
the operation information includes information pertinent to an interval of the video data not yet produced when the video data recorded in the recording unit is erased therefrom.

12. The server device as claimed in claim 4, wherein
the operation information includes information pertinent to an interval of the video data not yet produced when the video data recorded in the recording unit is erased therefrom.

13. The viewing terminal device as claimed in claim 2, wherein
the operation information includes information pertinent to an interval of the deleted video data when the video data recorded in the recording unit is partly deleted therefrom.

14. The server device as claimed in claim 4, wherein
the operation information includes information pertinent to an interval of the deleted video data when the video data recorded in the recording unit is partly deleted therefrom.

15. The viewing terminal device as claimed in claim 2, wherein
the operation information includes information pertinent to details of a program protect which disallows the video data recorded in the recording unit to be deleted therefrom.

16. The server device as claimed in claim 4, wherein
the operation information includes information pertinent to details of a program protect which disallows the video data recorded in the recording unit to be deleted therefrom.

17. The viewing terminal device as claimed in claim 2, wherein
the operation information includes information pertinent to a playlist point registration site of the video data recorded in the recording unit.

18. The server device as claimed in claim 4, wherein
the operation information includes information pertinent to a playlist point registration site of the video data recorded in the recording unit.

19. The viewing terminal device as claimed in claim 2, wherein
the operation information includes information pertinent to a dubbing operation of the video data recorded in the recording unit.

20. The server device as claimed in claim 4, wherein
the operation information includes information pertinent to a dubbing operation of the video data recorded in the recording unit.

21. The viewing terminal device as claimed in claim 2, wherein
the operation information includes information pertinent to a reserved recording of the video data recorded in the recording unit.

22. The server device as claimed in claim 4, wherein
the operation information includes information pertinent to a reserved recording of the video data recorded in the recording unit.

23. The viewing terminal device as claimed in claim 1, wherein
the comment information includes information pertinent to:
the broadcast program viewed by the user;
a comment on the broadcast program made by the user; and
a scene of the broadcast program on which the comment is made.

24. The server device as claimed in claim 3, wherein
the comment information includes information pertinent to:
the broadcast program viewed by the user;
a comment on the broadcast program made by the user; and
a scene of the broadcast program on which the comment is made

25. The viewing terminal device as claimed in claim 2, wherein
the comment information includes information pertinent to:
a recorded broadcast program corresponding to the video data recorded in the recording unit;
a comment on the recorded broadcast program made by the user; and
a scene of the recorded broadcast program on which the comment is made.

26. The server device as claimed in claim 4, wherein
the comment information includes information pertinent to:
a recorded broadcast program corresponding to the video data recorded in the recording unit;
a comment on the recorded broadcast program made by the user; and
a scene of the recorded broadcast program on which the comment is made.

27. The viewing terminal device as claimed in claim 2, wherein
the viewing statistical information includes:
a viewing rate in each channel of the broadcast wave;
changes of the viewing rate in each channel; and
a reservation recording ratio in each channel.

28. The server device as claimed in claim 4, wherein
the viewing statistical information may include:
a viewing rate in each channel of the broadcast wave;
changes of the viewing rate in each channel; and
a reservation recording ratio in each channel.

29. The viewing terminal device as claimed in claim 2, wherein
the reproduction unit identifies an arbitrary scene in the video data recorded in the recording unit based on the viewing statistical information and skips to and reproduces the arbitrary scene when the video data is reproduced.

30. The viewing terminal device as claimed in claim 2, wherein
the display unit displays thereon the comment inputted by the user based on a scene of the broadcast program on which the comment is made when the reproduction unit reproduces the video data.

31. The viewing terminal device as claimed in claim 30, wherein
the viewing statistical information includes:
a response made by the user on the comment displayed on the display unit; and
a program complementary information which helps the broadcast program to be better understood.

32. A participating program sharing system, comprising:
the viewing terminal device as claimed in claim 1; and
the server device as claimed in claim 3.
